(19) United States
(12) Patent Application Publication
(10) Pub. No.: US 2025/0361928 A1
(43) Pub. Date: Nov. 27, 2025

(54) BALL SCREW DRIVE AND ELECTROMECHANICAL ACTUATOR

(71) Applicant: Schaeffler Technologies AG & Co. KG, Herzogenaurach (DE)

(72) Inventors: Dieter Adler, Herzogenaurach (DE); Stefan Michaloudis, Nürnberg (DE); Armin Gerner, Pommersfelden (DE); Nicky Heinrich, Neustadt a. d. Aisch (DE); Florian Fell, Aurachtal (DE); Bernhard Wiesneth, Erlangen (DE)

(73) Assignee: Schaeffler Technologies AG & Co. KG, Herzogenaurach (DE)

(21) Appl. No.: 18/866,574

(22) PCT Filed: Mar. 28, 2023
(86) PCT No.: PCT/DE2023/100237

§ 371 Date: Nov. 18, 2024

(30) Foreign Application Priority Data
Jun. 3, 2022 (DE) 10 2022 114 070.9

(51) Int. Cl. F16H 25/24; B60T 13/74; F15B 15/14

(52) U.S. Cl. CPC F16H 25/24; B60T 13/745; F15B 15/1423; F15B 2015/1495

(57) ABSTRACT

A ball screw drive, in particular for an actuator of a hydraulic brake system, includes two spindle drive elements, namely a threaded spindle and a spindle nut which can be rotated relative to the threaded spindle. One of the spindle drive elements is provided as a rotatable drive element, and the second spindle drive element is provided as an output element which can be moved in a secured manner against rotation. The ball screw drive additionally includes a damping element that is configured as an annular element concentric relative to a central axis of the threaded spindle. The annular element is rigidly connected to one of the two spindle drive elements, and can be simultaneously rotated and moved relative to the other spindle drive element in a play-free manner.

### CROSS-REFERENCE TO RELATED APPLICATIONS

This application is the U.S. National Phase of PCT Application No. PCT/DE2023/100237 filed on Mar. 28, 2023, which claims priority to DE 10 2022 114 070.9 filed on Jun. 3, 2022, the entire disclosures of which are incorporated by reference herein.

### TECHNICAL FIELD

The disclosure relates to a ball screw drive. The disclosure further relates to an electromechanical actuator, in particular a brake actuator, having a ball screw drive.

### BACKGROUND

DE 10 2015 209 600 B4 discloses a ball screw drive which is intended for use in an electromechanical brake booster or in an electromechanical parking brake. The known ball screw drive comprises an anti-rotation element that simultaneously forms an axial stop.

DE 10 2019 111 144 A1 discloses a spindle drive with anti-rotation protection, which is intended in particular for use in a rear axle steering system of a motor vehicle. In this case, an anti-rotation element is designed as a damping multi-part element.

A combined vehicle brake is known from EP 2 207 982 B1, which has a hydraulically actuated service brake and an electromechanically actuated emergency brake device. The latter brake device works with a ball screw drive, wherein the spindle nut of the ball screw drive is provided as its output element. Spring elements are arranged between rolling elements of the ball screw drive and can be designed as helical compression springs or elastomer springs.

### SUMMARY

The disclosure addresses the problem of further developing a ball screw drive suitable for use in a brake system of a motor vehicle, compared to the aforementioned prior art, in particular with regard to damping properties.

This problem is solved according to a ball screw drive having the features described herein. The ball screw drive comprises two spindle drive elements according to a basic concept known per se, namely a threaded spindle and a spindle nut which can be rotated relative to the threaded spindle, wherein one of the two spindle drive elements is provided as a rotatable drive element of the ball screw drive and the other spindle drive element is provided as an output element which can be moved in a manner secured against rotation. Furthermore, a damping element of the ball screw drive is provided.

According to an example embodiment, this damping element is rigidly connected to one of the two spindle drive elements and can be rotated and moved relative to the other spindle drive element such that the damping element is free of play. This also includes a slight preload, which the damping element is subjected to. In particular, the damping element is designed as an annular element which is concentric relative to the central axis of the threaded spindle.

The ball screw drive can be used in particular in an electromechanical actuator, forming a component of a hydraulic brake system of a vehicle.

Compared to conventional damping mechanisms, particular advantages of the ball screw drive according to the example embodiments described herein can be achieved, in particular in that the damping element in the form of a damping ring which is concentric relative to the central axis of the threaded spindle is placed particularly close to the components of the ball screw drive, through which the driving rotary movement is converted into a linear movement. It is taken into account here that, in an example embodiment, the damping element absorbs relative movements to a greater extent than in the case of conventional damping components, which are arranged between a driven push rod and a housing, for example.

According to a first possible group of designs, the threaded spindle works as a rotatable drive element and the spindle nut as an axially movable output element of the ball screw drive. In this regard, the damping element can, for example, be connected to the spindle nut and simultaneously contact an element fixed to the housing. This means that the annular damping element, i.e., in a typical embodiment the damping ring, is moved in the axial direction together with the spindle nut relative to the threaded spindle during operation of the ball screw drive. During the entire movement, the damping ring contacts an inner wall of an element fixed to the housing, i.e., a wall which is provided either directly by a housing of the ball screw drive or by an element rigidly connected to the housing.

In an alternative embodiment, which also belongs to the first group of designs, the damping element is fastened on the threaded spindle, wherein it simultaneously contacts an element that is rigidly coupled to the spindle nut. In this case, the damping element, in particular in the form of a damping ring, thus constitutes a rotating element of the ball screw drive, and a relative movement occurs between the damping ring and the spindle nut. In particular, the spindle nut can be rigidly connected to a tubular machine part, the inner surface of which is contacted by the damping element. When the ball screw drive is designed as a component of an actuator of a hydraulic brake system, the tubular machine part is fastened in particular to a hydraulic piston or is formed by such a piston. In this case, the piston has a cavity into which the threaded spindle plunges together with the damping ring. Otherwise, the tubular machine part can be a separate piston support.

According to a second possible group of designs, the spindle nut is the rotatable drive element that is in a fixed axial position and the threaded spindle is the axially movable output element of the ball screw drive, which is secured against rotation. In this regard, the damping element can be arranged on the outer circumferential surface of the spindle nut and simultaneously contact an inner circumferential surface of an element rigidly connected to the threaded spindle. A relative movement thus occurs between the latter element and the damping element, among others. In this case, the element contacted by the damping element in the sense of a sliding contact can also be designed as a hollow piston or as an extension piece attached to such a piston.

According to a further embodiment belonging to the second group of designs, the damping element is fastened on the threaded spindle and simultaneously contacts a sleeve-shaped element provided for driving the spindle nut. The latter element can be a section of the spindle nut itself, or an element adjoining the spindle nut and rotating together with the spindle nut. In both cases, the damping ring is not only rotated but also moved relative to the spindle nut during operation of the ball screw drive.

In addition, embodiments exist in which the damping element is held within the threaded spindle and simultaneously contacts the threaded spindle so that the damping element is in sliding contact with the thread of the single-start or multi-start threaded spindle. In these embodiments, either the spindle nut or the threaded spindle can be provided as the driving element of the ball screw drive.

In the various designs described above by way of example, the damping ring can be designed as an elastic, vibration-damping element of the ball screw drive, for example as a rubber-elastic element. In order to set suitable damping properties for a specific application, a selection can, in particular, be made from damping materials with different Shore hardnesses. The geometry of the damping ring also has an influence on its damping properties. Finally, the damping properties can be influenced in a targeted manner by providing preloads, in particular in the radial direction, and oversizes, for example between the damping ring on the one hand and a sleeve or housing on the other.

As far as the fastening of the damping ring is concerned, it is possible, for example, to fix it in the axial direction in a recess or with the aid of a separate retaining element, in particular in the form of a retaining plate. Forces that act between the damping ring and a component that contacts the damping ring and is movable linearly and/or rotationally relative to the damping ring, affect both the damping properties and the sliding friction that occurs during operation. It has been shown that even with a low-friction design, the damping ring has a significant effect, particularly in reducing amplitudes in the range of natural frequencies.

In all embodiments, a particular advantage of the disclosure is that the damping ring significantly reduces bending vibrations within the ball screw drive, which is particularly important with regard to the acoustic behavior of the ball screw drive. The damping ring has a particularly pronounced effect if it is mounted at a point on the ball screw drive where a maximum bending vibration amplitude would otherwise be observed.

### BRIEF DESCRIPTION OF THE DRAWINGS

Five exemplary embodiments of the disclosure are explained in more detail below by means of drawings. In the figures:

FIG. 1 shows a comparative design of a ball screw drive with a driven threaded spindle, which is not in accordance with the invention,

FIG. 2 shows a first design of a ball screw drive with a driven threaded spindle,

FIG. 3 shows a first design of a ball screw drive with a driven spindle nut,

FIG. 4 shows a second design of a ball screw drive with a driven spindle nut,

FIG. 5 shows a third design of a ball screw drive with a driven spindle nut, and

FIG. 6 shows a further design of a ball screw drive with a driven threaded spindle.

### DETAILED DESCRIPTION

Unless otherwise stated, the following explanations relate to all the exemplary embodiments. Parts that correspond to each other or have basically the same effect are denoted with the same reference signs in all the figures.

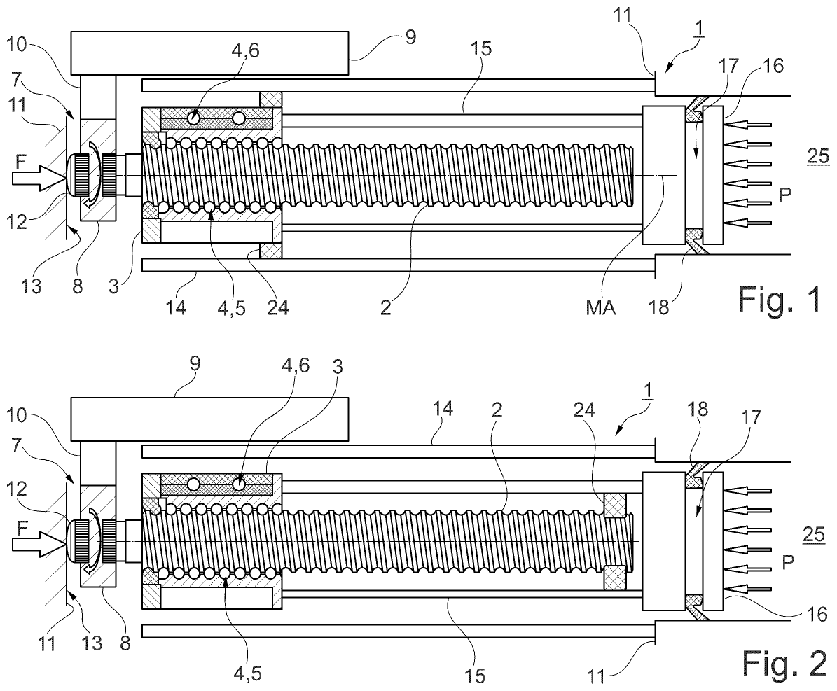

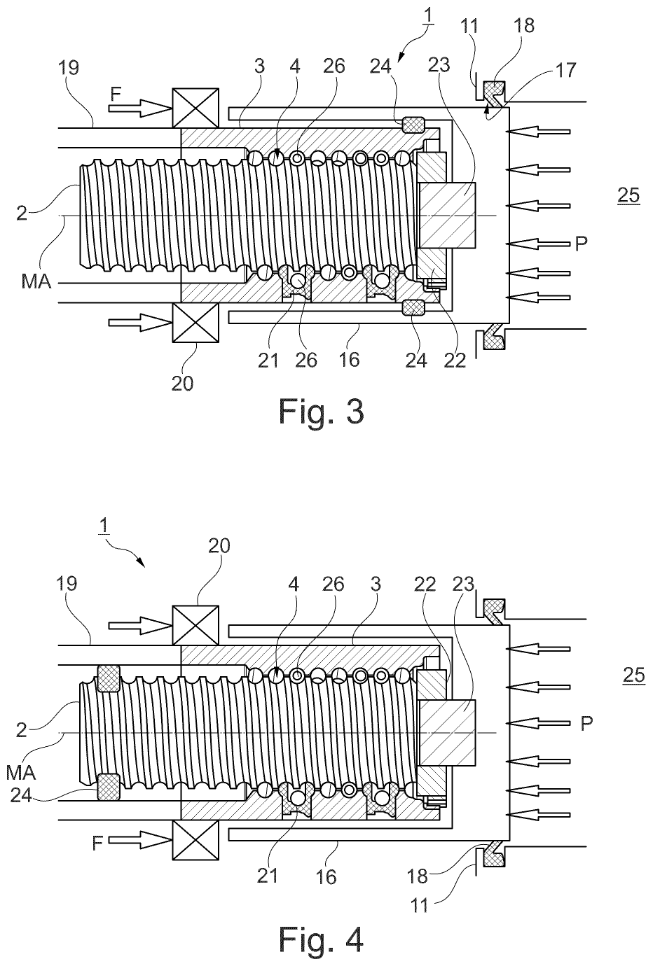

A ball screw drive 1 comprises a threaded spindle 2 as the first spindle drive element and a spindle nut 3 as the second spindle drive element. A ball track 4 for balls 26 as rolling elements is formed between the spindle drive elements 2, 3. A load section of the ball track 4 is designated with 5. In the embodiments according to FIGS. 1 and 2, an external recirculation of the balls 26 is provided. In these cases, return sections of the ball track 4 are designated with 6. In the cases of FIGS. 3 and 4, an internal recirculation of the balls 26 is provided. In these cases, recirculation elements for the internal recirculation are designated with 21. The common central axis of the threaded spindle 2 and the spindle nut 3 and thus of the entire ball screw drive 1 is designated with MA in all cases.

The ball screw drive 1 moves a piston 16 in a housing 11. A pressure p of a hydraulic fluid acts on the piston 16. Forces acting in the axial direction of the ball screw drive 1 are generally designated with F. The piston 16 is sealed by a seal 18, which is inserted into a groove 17. The groove 17 is located in the piston 16 in the cases of FIGS. 1 and 2 and in the housing 11 in the cases of FIGS. 3 and 4.

In the designs according to FIGS. 1 and 2, the threaded spindle 2 acts as the driving element of the ball screw drive 1. In the cases outlined, a belt transmission 7 in the form of a belt drive is connected upstream of the ball screw drive 1. Here, a belt pulley 8 of the belt transmission 7 is connected to the threaded spindle 2 for conjoint rotation. A further driving belt pulley of the belt transmission 7 is connected to the motor shaft of an electric motor 9 for conjoint rotation. In the cases outlined in FIGS. 1 and 2, the motor shaft of the electric motor 9 is arranged parallel to the central axis MA. The belt of the belt transmission 7 is designated with 10.

The threaded spindle 2 or a part connected to the threaded spindle 2 for conjoint rotation, has a cap-shaped end piece 12 projecting beyond the belt pulley 8, which strikes approximately at a point on an inner wall 13 of the housing 11. In a more complex variant of the ball screw drive 1, which is not shown, an axial bearing or an angular contact ball bearing supporting axial forces F could also be arranged at the corresponding point, for example.

The spindle nut 3 of the ball screw drives 1 according to FIGS. 1 and 2 is secured against rotation in a manner not shown. A tubular piston support 15 is connected to the spindle nut 3, via which compressive forces in particular can be transmitted to the piston 16. A tube that is rigidly connected to the housing 11 and concentrically surrounds the piston support 15 is designated with 14.

In the comparative design according to FIG. 1, an annular damping element 24 is inserted between the outer circumferential surface of the spindle nut 3 and the tube 14 fixed to the housing. If the threaded spindle 2 rotates, the damping element 24 is moved in the axial direction together with the spindle nut 3. The damping element 24 does not rotate in this case. The distance between the damping ring 24 and the piston 16, which delimits a pressure chamber 25, remains constant with all settings of the ball screw drive 1.

In the exemplary embodiment according to FIG. 2, the damping ring 24 is fastened on the threaded spindle 2 and is located close to that end of the threaded spindle 2 which faces the piston 16. When the threaded spindle 2 rotates, the damping ring 24 rotates relative to the inherently rigid arrangement of the spindle nut 3, piston support 15 and piston 16, and the damping ring 24 slides on the inner circumferential surface of the piston support 15. Simultaneously, the piston support 15 is moved in the axial direction on the damping element 24.

In the exemplary embodiments according to FIGS. 3 and 4, the spindle nut 3 is the driving element of the ball screw drive 1. The spindle nut 3 is extended in the axial direction in the form of a drive section 19, which does not have a threaded structure. The section 19 and thus the entire spindle nut 3 is electrically driven by a reduction gear 7, which is not shown in this case. Alternatively, an electric direct drive of the spindle nut 3 is possible. Axial forces F acting on the spindle nut 3 are in any case received by a rolling bearing 20, in particular in the form of an angular contact ball bearing. In the cases shown in FIGS. 3 and 4, the piston 16 is hollow, and not only the threaded spindle 2 but also the spindle nut 3 engages in the cavity formed by the piston 16. A rigid connection between the threaded spindle 2 and the piston 16 is established via an annular element 22 and a cylindrical element 23.

In the exemplary embodiment according to FIG. 3, the annular damping element 24 is inserted into an annular gap between the outer circumferential surface of the spindle nut 3 and the inner circumferential surface of the piston 16. The damping ring 24 rotates together with the spindle nut 13 and is simultaneously moved in the axial direction relative to the piston 16 when the ball screw drive 1 is actuated. The measurable distance in the axial direction between the damping ring 24 and the surface of the piston 16 delimiting the pressure chamber 25 is therefore variable.

In the exemplary embodiment according to FIG. 4, the damping ring 24, in principle comparable to the design according to FIG. 2, is fastened on the threaded spindle 2. Simultaneously, in the case of FIG. 4, the damping ring 24 contacts the inner circumferential surface of the cylindrical drive section 19. As the drive section 19 rotates together with the entire spindle nut 3, a relative rotation occurs between the damping ring 24 and the spindle nut 3. The distance between the damping ring 24 and the piston 16 is constant in the case of FIG. 4. In the case of both FIG. 3 and FIG. 4, the arrangement of the threaded spindle 2 and piston 16 is guided in a manner secured against rotation in the housing 11.

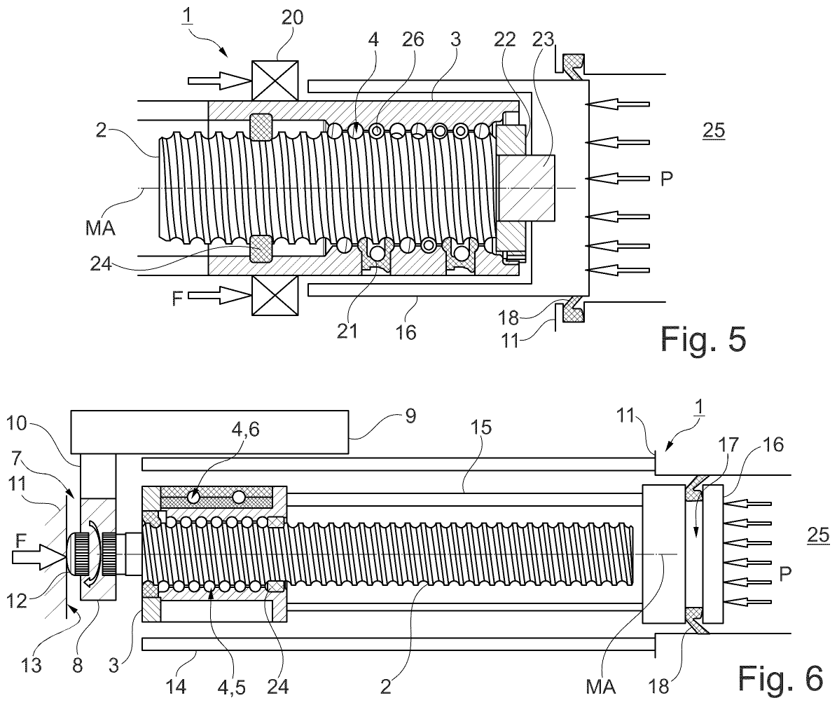

The exemplary embodiment according to FIG. 5 differs from the exemplary embodiment according to FIG. 4, mainly in that the damping ring 24 is fastened in the spindle nut 3. Thus, in this case too, a movement is provided for between the damping ring 24 and one of the two spindle drive elements 2, 3, in this case the threaded spindle 3. In this regard, the flexible damping ring 24, which rotates together with the spindle nut 3, rests on the thread of the threaded spindle 3 under a slight preload.

In the exemplary embodiment according to FIG. 6, the damping ring 24 is also held in the inner circumferential surface of the spindle nut 3, and in this case, as in the variant according to FIG. 2, the threaded spindle 3 acts as the drive element of the ball screw drive 1. In the constellation according to FIG. 6, the damping ring 24, which is under a slight preload, also contributes in particular to the damping of bending vibrations.

### LIST OF REFERENCE SYMBOLS

1 Ball screw drive
2 Threaded spindle
3 Spindle nut
4 Ball track
5 Load section
6 Return section
7 Belt transmission
8 Belt pulley
9 Electric motor
10 Belt
11 Housing
12 Cap-shaped end piece
13 Inner wall
14 Tube fixed to the housing
15 Piston support
16 Piston
17 Groove
18 Seal, inserted into the groove 17
19 Drive section of the spindle nut
20 Rolling bearing
21 Recirculation element for internal recirculation
22 Annular element
23 Cylindrical element
24 Annular damping element
25 Pressure chamber
26 Ball
F Force
MA Central axis
p Hydraulic pressure

1. A ball screw drive comprising:
a threaded spindle, and
a spindle nut configured to be rotated relative to the threaded spindle, and one of the threaded spindle or the spindle nut is a rotatable drive element and a remaining one of the threaded spindle or the spindle nut is an output element configured to move without rotation, and
a damping element rigidly connected to the one of the threaded spindle or the spindle nut, the damping element configured to be moved without play relative to the remaining one of the threaded spindle or the spindle nut.

2. The ball screw drive according to claim 1, wherein the threaded spindle is the rotatable drive element and the spindle nut is the output element, and the spindle nut is configured to be axially movable.

3. The ball screw drive according to claim 2, wherein the damping element is mounted to the threaded spindle and engages a piston support rigidly coupled to the spindle nut.

4. The ball screw drive according to claim 1, wherein the spindle nut is the rotatable drive element and the threaded spindle is the output element, and the threaded spindle is configured to be axially movable.

5. The ball screw drive according to claim 4, wherein the damping element is arranged on outer circumferential surface of the spindle nut and simultaneously engages an inner circumferential surface of a hollow piston rigidly connected to the threaded spindle.

6. The ball screw drive according to claim 5, wherein the damping element is fixed on the threaded spindle and simultaneously engages a sleeve-shaped element configured for driving the spindle nut.

7. The ball screw drive according to claim 2, wherein the damping element is held in the spindle nut and simultaneously engages the threaded spindle.

8. The ball screw drive according to claim 1, wherein the damping element is configured as an annular element arranged concentrically to a central axis of the threaded spindle.

9. An electromechanical actuator of a hydraulic brake system, comprising the ball screw drive according to claim 1.

10. The electromechanical actuator of claim 9, further comprising a piston fixed to the one of spindle nut or the threaded spindle and the piston is configured to receive a hydraulic fluid pressure.

11. The ball screw drive according to claim 1, wherein the damping element is an elastic element.

12. The ball screw drive according to claim 11, wherein the damping element is arranged radially between the threaded spindle and the spindle nut.

13. The ball screw drive according to claim 12, wherein the damping element is fastened to the spindle nut and rests directly on a thread of the threaded spindle.

14. The ball screw drive according to claim 3, wherein the damping element is arranged radially between the threaded spindle and the piston support and the damping element slidably engages the piston support.

15. The ball screw drive according to claim 5, wherein the damping element rotates together with the spindle nut and moves axially relative to the hollow piston.

16. A ball screw drive comprising:
a threaded spindle, and
a spindle nut configured to be rotated relative to the threaded spindle, and one of the threaded spindle or the spindle nut is a rotatable drive element and a remaining one of the threaded spindle or the spindle nut is an output element configured to move without rotation,
a piston fixed to one of the threaded spindle or the spindle nut, the piston configured to receive a hydraulic fluid pressure, and
an elastic vibration damping element: i) rigidly connected to the one of the threaded spindle or the spindle nut, and ii) configured to be moved without play relative to the remaining one of the threaded spindle or the spindle nut.

17. The ball screw drive of claim 16, further comprising a plurality of balls disposed between the threaded spindle and the spindle nut.

18. The ball screw drive of claim 16, wherein the elastic vibration damping element is annularly shaped.

19. The ball screw drive of claim 16, wherein the piston and spindle nut move together in an axial direction.

20. The ball screw drive of claim 16, wherein the piston and threaded spindle move together in an axial direction.
